(19) United States
(12) Patent Application Publication
(10) Pub. No.: US 2009/0204551 A1
(43) Pub. Date: Aug. 13, 2009

(54) Learning-Based Method for Estimating Costs and Statistics of Complex Operators in Continuous Queries

(75) Inventors: Min Wang, Cortlandt Manor, NY (US); Sriram K Padmanabhan, San Jose, CA (US); Like Gao, San Diego, CA (US)

Correspondence Address: GEORGE A. WILLINGHAN, III;AUGUST LAW, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 12/364,578

(22) Filed: Feb. 3, 2009

Related U.S. Application Data
(63) Continuation-in-part of application No. 10/984,323, filed on Nov. 8, 2004, now abandoned.

(51) Int. Cl. G06Q 10/00; G06F 15/18; G06N 5/02

(52) U.S. Cl. 705/400; 706/12; 706/47; 706/52

(57) ABSTRACT

A learning-based method for estimating costs or statistics of an operator in a continuous query includes a cost estimation model learning procedure and a model applying procedure. The model learning procedure builds a cost estimation model from training data, and the applying procedure uses the model to estimate the cost associated with a given query. The learning procedure uses a feature extractor, a confidence adjustor and a cost estimator. The feature extractor collects relevant training data and obtains feature values. The extracted feature values are associated with costs and used to create the cost estimator. The extracted feature values, the associated costs, the cost estimator, and a user interface are used to create a confidence adjuster. When applying the confidence adjuster and the cost estimator to a continuous stream of data, the feature extractor extracts feature values from the data stream, uses the extracted feature values as input into the confidence adjuster to determine whether or not the cost estimator should be used, and if so, uses the extracted feature values as inputs into the cost estimator to obtain the desired cost values.

### CROSS-REFERENCE TO RELATED APPLICATIONS

The present application is a continuation-in-part of co-pending U.S. application Ser. No. 10/984,323, filed Nov. 9, 2004. The entire disclosure of that application is incorporated herein by reference.

### FIELD OF THE INVENTION

The field of the invention is directed to data base query optimization.

### BACKGROUND OF THE INVENTION

Long standing queries, also referred to as continuous queries, are issued once and evaluated continuously, for example over a continuous stream of data, at regular intervals, once every day, or at the occurrence of a pre-defined event, for example every time new data are added to a database. Continuous queries are utilized in a variety of applications, in particular applications that monitor streaming data sources for the occurrence of specific events. The notion of continuous queries as a class of queries that are issued once and then run continuously over databases was introduced in D. Terry, D. Goldberg, D. Nichols and Oki, Continuous Queries Over Append-Only Databases, International Conference on Management of Data Proceedings, San Diego, Calif., pp. 321-330 (1992). In the decade that followed, the database research community showed great interest in continuous queries. This interest increased sharply due to the emerging needs of Data Stream Management Systems (DSMS).

The difference between a traditional file system, for example a Database Management System (DMS), and a DSMS is described in S. Babu and J. Widom, Continuous Queries Over Data Streams, Technical Report, Stanford University Database Group (March 2001). Traditional file systems expect all data to be managed within some form of persistent data set, i.e. a stored data set. A stored data set is appropriate when significant portions of the data are queried again and again, and updates are small or relatively infrequent. In a DSMS, data are contained in a data stream that is possibly unbounded, representing data that are changing constantly, often exclusively through insertions of new elements. Therefore, operations that cover large portions of the data contained within the data stream multiple times are either unnecessary or impractical.

As in traditional database systems, optimal query execution plans for continuous queries in any DSMS are desirable. Different query optimization frameworks for DSMS's have been proposed in recent years. The two most prominent proposed frameworks are rate-based query optimization frameworks, as illustrated in S. Viglas and J. F. Naughton, Rate-Based Query Optimization for Streaming Information Sources, Proceedings of the 2002 ACM SIGMOD International Conference on Management of Data, pp. 37-48, Madison, Wis., Jun. 3-6 (2002), and continuously adaptive continuous queries over streams framework, as illustrated in S. Madden, M. A. Shah, J. M. Hellerstein and V. Raman, Continuously Adaptive Continuous Queries Over Streams, Proceedings of the 2002 ACM SIGMOD International Conference on Management of Data, pp. 49-60, Madison, Wis., Jun. 3-6 (2002). In both frameworks, a fundamental building block is accurate cost estimation for various types of operators in the continuous queries. Cost estimation refers to the estimated total resource usage necessary to execute the query. A unit of cost does not directly equate to any actual elapsed time but provides a rough, relative estimate of the resources, i.e. cost, required by the database manager to execute two plans for the same query. Cost is derived from a combination of central processing unit cost in number of executed instructions and input-output cost in numbers of seeks and page transfers.

In order to reduce cost in a continuous query system, the amount of storage and computation that is required to satisfy many simultaneous queries running in the system is minimized. Given thousands of queries over dozens of data sources, queries will overlap significantly in the data sources they are analyzing. Query processing is further complicated by the long running nature of continuous queries. For example, query cost estimates that were accurate when a query was first posed may be wrong at some later time but before the query is actually removed from a given system.

While the cost of simple operators can be estimated easily, the cost of complex user-defined operators in continuous queries is very difficult to estimate using any traditional cost estimation methods. In addition, the cost of these complex, user-defined operators can vary significantly over time. Inaccurate cost estimation typically results in a sub-optimal query execution plan that ultimately results in poor performance.

A variety of methods are used to estimate the cost associated with a query including the histogram method, curve fitting, sampling and methods based on query feedback. The histogram method is most commonly used in database systems due to its computational efficiency and independence of data distribution. A feature common to each of these methods is an attempt to capture the underlying data distribution as precisely as possible under certain storage constraints. These captured data distributions are then used to estimate the cost of operators.

When dealing with continuous queries, a different approach is needed due to the difference between a traditional query and a continuous query. In a traditional query, the database is assumed to be static, and the queries are ad-hoc. Therefore, the system needs to handle any possible query, which is why most existing techniques that are applied to static databases attempt to capture the entire underlying data distribution. In a continuous query, however, the query is long standing, and the database changes, sometimes as often as each time the query is evaluated.

### SUMMARY OF THE INVENTION

The exemplary aspects of the present invention are directed to methods for estimating cost and statistics of operators in continuous queries over a changing database or stream of data. The continuous query is substantially fixed or static compared to the stream of data. The method in accordance with exemplary aspects of the present invention only considers or analyzes portions of the data stream that are relevant to a given query operator. In addition, the method considers the evolution of any changes in the data stream since the content of the data stream changes over time.

The method in accordance with exemplary aspects of the present invention is a learning-based method for directly estimating cost and statistics that includes an estimation model learning procedure and an estimation model applying procedure. The estimation model learning procedure includes a feature extractor, a cost estimator, and a confidence adjustor. The feature extractor is used to obtain feature values and costs from streaming data in training runs, to reduce data volume and to extract relevant parts of the data. In one embodiment, when the database is updated, the feature extractor works incrementally to increase the efficiency. The cost estimator is used to build a cost estimation model by using the feature values extracted from the training data. The confidence adjustor is used to assess the reliability of the cost estimator by using the feature values extracted from the training data, along with some user pre-defined thresholds and rules. The feature extractor obtains these feature values from the underlying data, and the cost estimator and confidence adjustor use the extracted feature values as inputs. The applying procedure uses the cost estimation model to calculate costs and statistics for an actual data stream, along with the confidence of the estimation. For a given stream of data to be queried, the feature extractor extracts the feature values. The cost estimator uses the extracted feature values to obtain the cost estimate. The confidence adjustor uses the extracted feature values to obtain the confidence measure.

In accordance with one exemplary embodiment, the present invention is directed to a method for estimating costs for continuous queries over streaming data. In accordance with this method, a query cost estimator capable of associating costs to features in a stream of data for a continuous query is created, and a confidence adjustor capable of associating a confidence level to the costs produced by the query cost estimator is created. The confidence adjustor and the cost estimator are applied to the features in one or more streams of data to estimate costs associated with conducting the continuous query over the streams of data.

In one embodiment, creation of the cost estimator includes providing training data from historical runs of the continuous query, the training data containing feature values and historical costs, extracting relevant feature values from the training data, associating historical costs with the relevant feature values and using the extracted feature values and associated historical costs to create the cost estimator. In addition, creation of the confidence adjustor includes applying the extracted feature values to the cost estimator to obtain estimated costs and using the estimated costs, the associated historical costs from the training data and user criteria to create the confidence adjustor. In one embodiment, the user criteria are obtained from a user interface.

In one embodiment, the user criteria are a set of application specific rules that include the estimated costs and the historical costs as inputs and confidence values that indicate whether or not to use the estimated costs as an output. In one embodiment, the application specific rules also include frequencies for given difference values between estimated cost and historical costs among all the training data as inputs.

In one embodiment, creating the confidence adjustor also includes creating a confidence adjustor decision tree. In creating the decision tree, feature values that are extracted from historical training data are used in the cost estimator to estimate costs associated with the historical data, and actual historical costs are also from the historical training data associated with the extracted feature values. The actual historical costs, estimated costs and extracted feature values are used in a decision tree generating algorithm to produce a historical data-based confidence level decision tree. In one embodiment, the confidence adjustor decision tree is a historical data-based confidence level decision tree containing a plurality of decision nodes, each decision node having index ranges derived from feature values obtained from historical data, and a plurality of leaf nodes, each leaf node having a confidence level of cost estimation.

In one embodiment, applying the confidence adjustor includes extracting relevant feature values from the stream of data and inputting the extracted feature values into the confidence adjustor to obtain a confidence level to be associated with cost estimations associated with the extracted relevant feature values. In addition, applying the cost estimator and the confidence adjustor includes accessing a stream of data, extracting relevant feature values from the stream of data and inputting the extracted feature values into the cost estimator to derive the associated costs if the obtained confidence level is above a prescribed threshold value.

### BRIEF DESCRIPTION OF THE DRAWINGS

FIG. 1 is a flow chart of an embodiment of a method for estimating costs and their confidences in continuous queries in accordance with exemplary aspects of the present invention;

FIG. 2 is an illustration of a similarity-based search over a streaming time series;

FIG. 3 is an illustration of a discrete Fourier transformation of a pattern series;

FIG. 4 is an illustration of a sliding discrete Fourier transformation of a streaming time series;

FIG. 5 is an embodiment of a plot of pattern ranking versus approximation coefficients for use in determining index ranges associated with streaming time series;

FIG. 6 is a flow chart of an embodiment of creating a decision tree cost estimator in accordance with exemplary aspects of the present invention;

FIG. 7 is a flow chart illustrating an embodiment of the application of the decision tree cost estimator for a continuous data stream;

FIG. 8 is a flow chart of an embodiment of creating a decision tree confidence adjustor in accordance with exemplary aspects of the present invention; and

FIG. 9 is a flow chart illustrating an embodiment of the application of the decision tree confidence adjustor for a continuous data stream.

### DETAILED DESCRIPTION

Exemplary aspects of the present invention are directed to methods for directly estimating cost and statistics in continuous, static queries over one or more continuously changing databases or streams of data. In one embodiment, queries monitor one or more streams of data for an indication or occurrence of an event. For example, queries can monitor banking or other financial transactions for an indication of identity theft or credit card fraud. In addition, queries can monitor the sales of certain commodities, i.e. fertilizer, or immigration activity for an indication of likely terrorist activity. In one embodiment, a given query analyzes one or more features in a given stream of data.

Unlike cost estimation methods for ad-hoc queries over static databases that capture the data distribution in advance and that use the captured data distribution to determine the cost of a specific query operator at the query evaluation time, methods in accordance with exemplary aspects of the present invention directly estimate the cost associated with a given query operator or feature from the input data contained in the stream of data. As used herein, cost refers to the estimated total resource usage necessary to execute the given query. These resources include processor usage, memory usage and network usage among others. In one embodiment, the cost of a query operator, COST, is determined from the input data D. This estimation is represented by the equation COST=f(D), where f is a fixed estimation function for the query operator for which cost is being estimated.

The estimated cost is associated with a confidence level that indicates the reliability of the cost estimation. Users may use this confidence, together with other criteria, to determine whether or not the estimated cost should be used. In one embodiment, this decision is determined from the input data D and the cost estimation. This decision is represented by the equation DEC=g(D,f(D)), where f is a fixed estimation function for the query operator for which cost is being estimated, and g is a decision function that includes the user criteria.

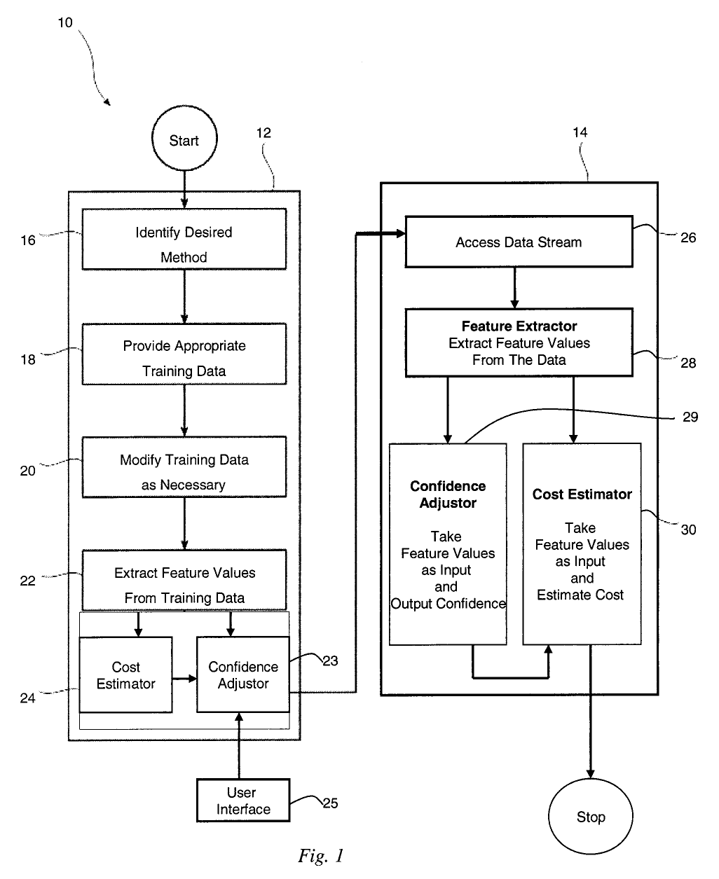

Referring to FIG. 1, an embodiment of a method for directly estimating and applying cost associated with a query 10 is illustrated. In one embodiment, the method for estimating and applying cost in a query includes a process for learning or creating a query cost estimator 12 and a process for applying the learned query cost estimator 14. The process for creating the cost estimator utilizes a user-defined sample or training stream of data, and the created cost estimator is applied to one or more actual streams of data over which the query is conducted. Initially, one or more desired methods for use in creating or building the cost estimator is identified 16. Suitable methods for use in building the cost estimator include learning-based methods, decision tree methods, regression, polynomial functions, histograms and combinations thereof. In general, strategies to create the cost estimator are classified into two approaches, analytic approaches and empirical approaches. In an analytic approach, the cost estimator that uses the extracted features or data as input is created by analyzing the underlying evaluation procedure of an operator, for example an operator within the given query. When these operators are complex or complicated or involve multiple resources, however, the empirical approach is preferably used to create the cost estimator, because experimental data of the continuous query can be used as training evaluation data, and available data mining algorithms can be used to build the cost estimator and to analyze the data.

Based upon the desired method for creating the cost estimator, appropriate training data are provided 18. The training data stream is created to simulate the complexities and ranges of data values for which a given query is to be utilized for monitoring. In one embodiment where the identified method includes using historical data to train a decision tree, the training data set contains actual data from historical runs of the query including query results and costs associated with obtaining those query results. Since the methods used to extract information and features from the data that are necessary to produce the cost estimator may require that the data be present in a particular form, the data that are provided and extracted can be converted into a data type or form that is suitable for use in the method identified for building the cost estimator 20.

Since any given stream of data represents a large volume of input data for the query to process and the types of input data contained in the stream of data are often complex, methods in accordance with exemplary aspects of the present invention focus on those aspects of the stream of data that are relevant to the query and that will produce results to the query in the most cost effective manner. Therefore, after the training data stream is provided, the features or data from the stream of data that are relevant to the query and the complex operators that constitute the query are extracted 22. Extracting the relevant data or feature values from the stream of data reduces the volume of data that is used or analyzed in creating the cost estimator. Another exemplary aspect of the present invention involves a method for extracting features for complex operators. In one embodiment, the feature extractor is determined manually in that the user defines the features within a given stream of data that are to be extracted. In another embodiment, a dedicated incremental procedure is developed to obtain feature values in order to reduce the overhead. A cost estimator is then built 24 using the values of the extracted data or features from the training data stream and the associated costs as inputs.

Once the cost estimator is built, the same feature values from the training data 22 are applied to the cost estimator to get the corresponding estimated costs. A confidence adjustor 23 is then built using the estimated costs, the associated actual costs from the training data 22, and the user criteria that are provided from a user interface 25. The user criteria is in the form of a set of application specific rules that take in as input the estimated cost, the actual costs, and optionally the frequency of the difference value between the estimated and actual cost among all the training data. It then gives a confidence value that indicates whether or not to use the estimated cost. An example rule of the criteria is “if the estimated cost is in the range of 80% to 120% of the actual cost and this happens more than 10% times among all training cases, then the estimated cost should be used with high confidence”.

Having built the cost estimator and the confidence adjustor, the query cost estimator is applied 14, for example to monitor one or more continuous streams of data. In order to apply the cost estimator, the data streams to be monitored are accessed 26, and the relevant features or data are extracted from the stream of data 28. The extracted feature values are used as inputs to the confidence adjustor, and the confidence adjustor outputs a confidence associated with that cost estimator 29. In one embodiment, the confidence level can be represented in the following form, CONF=c(e(D), where the functions e( ) represents feature extraction and the function c( ) represents the confidence adjustor. Based upon the outputted confidence, the decision is made whether or not to user the cost estimator. If the cost estimator is to be used, the extracted feature values are used as inputs to the cost estimator, and a cost associated with the data is calculated 30. In one embodiment, the fixed estimation function, f, that was introduced to define the estimated cost is decomposed to two components. The first component represents feature extraction 28, and the second component represents cost estimation 30. In particular, the fixed estimation function can be represented in the following form, COST=s(e(D)), where the functions e( ) represents feature extraction and the function s( ) represents the cost estimation.

Besides estimating cost, methods in accordance with exemplary aspects of the present invention are used to estimate other statistics of complex operators for continuous queries over streaming data. These statistics include output size. Overall, the cost estimation method in accordance with exemplary aspects of the present invention provides accurate estimates with low overhead.

Once the cost is estimated, the queries are conducted inversely by cost and weighted in accordance with the ones that are capable of yielding or producing a determination of the query the quickest, i.e. produce a negative result the quickest so that query evaluation can be stopped at the earliest point if a positive result to the query is unlikely.

If the decision is made 29 that the cost estimator should not be used, cost estimation 30 is bypassed, and the queries are informed that no cost estimation is available, since the cost estimation is not reliable according to the confidence adjustor. In this case, the query evaluation will choose other appropriate methods that are independent of the cost estimation to process the query, such as a native algorithm that scans the whole pattern set directly, or an index based algorithm that scans the pre-built index first, and then selectively scans part of the pattern set. This avoids the risk of using a very costly query evaluation plan that is based on the wrong cost estimation.

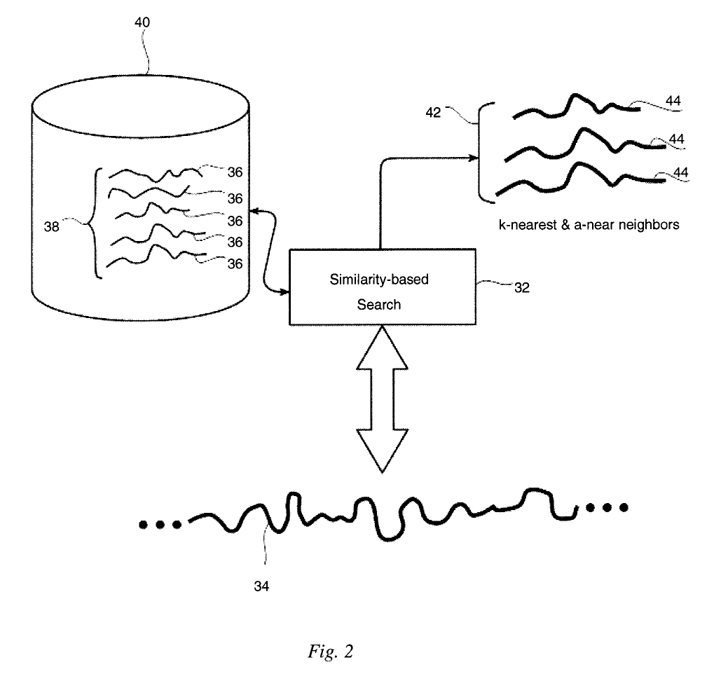

Referring to FIG. 2, an embodiment of the method for estimating costs associated with a continuous query over a stream of data is illustrated. The query 32 monitors an input data stream 34. As illustrated, the query 32 is a similarity-based search. Operators in a similarity-based query, at each time position, search the streaming time series in the input data stream 34 for time series patterns 36 defined in a pre-defined pattern set 38 contained, for example, in a database 40 or other computer readable storage medium that is accessible by the query 32. A streaming time series is an infinite sequence of real numbers whose values are assumed to arrive sequentially, and a time series 36 is a finite sequence of n real numbers.

The time series patterns 36 contained within the pre-defined pattern set 38 are selected based upon the similarity of these time series patterns 36 to streaming time series contained in the input data steam 34 that are of interest in the query. The similarity between a streaming time series contained within the input data stream 34 and each one of the time series patterns 36 is measured by the weighted Euclidean distance

$$sim ( S , {PT}_{i} ) = \sqrt{{\sum }_{0}^{n - 1} {( {q}_{i} - {s}_{t + i - n + 1} )}^{2} / n} ,$$

where PTᵢ=<p₀, p₁, . . . pₙ₋₁> is a time series pattern 36 and <sₜ₋ₙ₊₁, sₜ₋ₙ₊₂, . . . sₜ> is the n-suffix of the streaming time series S in the input data stream 34 up to time t.

Given an integer k, called a similarity rank, and a real number a, called a similarity threshold, a time series pattern 36 PTᵢ in the set of patterns 38 is a k-nearest and a-near neighbor of a given streaming time series in the input data stream 34 if there exist at most k−1 patterns 36 PTᵢ in the set of patterns 38 such that

sim(S,PTᵢ)>sim(S,PTⱼ)and sim(S,PTᵢ)≦a.

A k-nearest and a-near neighbor is also referred to as a k-a-near neighbor.

For a given stream of data 34, a given streaming time series and given values for similarity rank k and threshold a, the similarity-based search query 32 creates a solution set 42 containing a plurality of matching pattern time series 44 at each data arrival time t, which represents all k-a-near neighbors up to time t of the streaming time series from the original set of patterns 38.

In order to conduct the similarity-based search query 32 in the most cost effective way in accordance with exemplary aspects of the present invention, a query cost estimator is created for estimating the cost associated with the similarity-based search query, and the cost estimator is used to estimate the cost of conducting the query for a given stream of data. Initially, the use of historical data is identified as the method to be used to build the cost estimator and historical training data are provided for use in creating the cost estimator. The historical data include pattern and streaming time series data from historical runs and costs associated with these data.

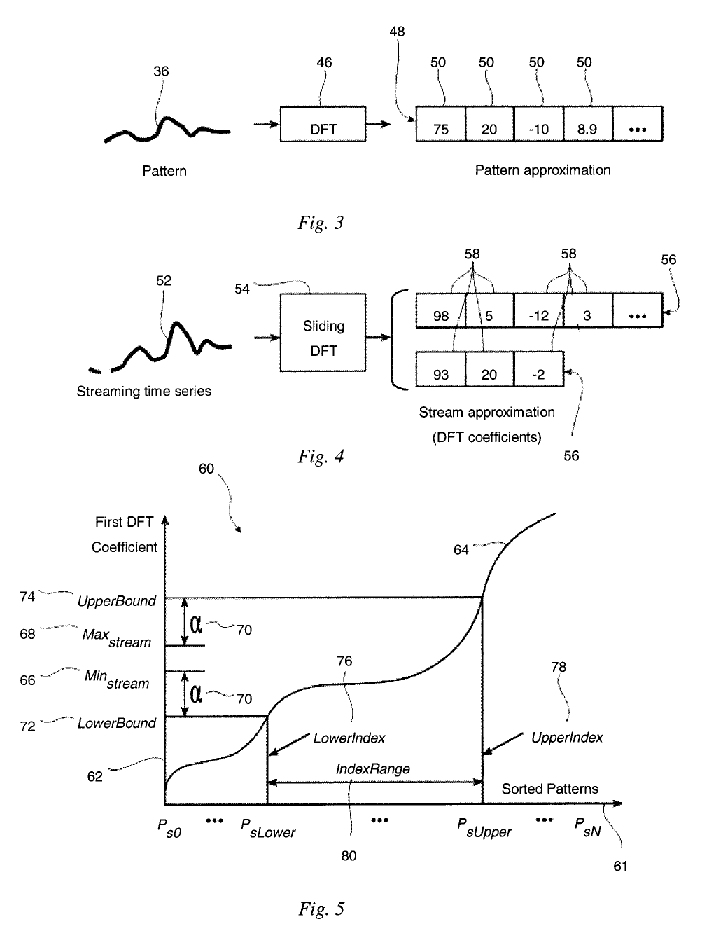

In order to build the cost estimator, feature values are extracted from the historical pattern and streaming time series data so as to minimize estimation overhead and to reduce the volume of data involved in the estimation process. In this embodiment in order to minimize the estimation overhead, the feature values in the historical data are converted using data approximations of the pattern time series and streaming time series contained in the historical data. Initially as illustrated in FIG. 3, each time series pattern 36 is approximated, preferably using Discrete Fourier Transform (DFT) 46. The DFT approximation yields a pattern approximation 48. Each time series pattern has a length n and is approximated by a plurality of its significant DFT coefficients 50. Although the larger the number of coefficients used the more accurate the approximation, each time series pattern is preferably approximated by the smallest possible number of significant DFT coefficients to keep the extraction process as simple as possible. Since each pattern time series is static, these approximations can be performed in advance using a standard n-point DFT operation and stored with the pattern in the database.

Having approximated the time series patterns, each streaming time series 52, as illustrated in FIG. 4, is also approximated using DFT, preferably sliding DFT 54 since streaming time series change over time. For example, a streaming time series of given length n can be viewed as a window of length n over the continuous data stream 34 being monitored. As the continuous data stream passes in front of this window over time, the content of the n-length streaming time series changes. The change in the streaming time series results in a change in the DFT approximation, and sliding DFT is used to provide the necessary incremental updating of the approximation. Therefore, sliding DFT 54 produces a plurality of streaming time series approximations 56. The streaming time series approximations contain coefficients that due to the changing streaming time series can vary from approximation to approximation. A plurality of streaming time series approximations is generated corresponding to each time series pattern length n. As with the time series patterns, each n-suffix of the streaming time series is approximated by the smallest number of significant DFT coefficients possible.

Having placed the pattern and continuous time series historical data in the desired format using DFT based approximations, feature values are then extracted from the data. In one embodiment, as illustrated in FIG. 5, a plot of the ranking of sorted pattern approximations versus DFT approximation coefficients 60 is created. For purposes of simplifying the embodiment, only the first DFT coefficients of the pattern time series and streaming time series approximations are used in the illustration. To create the plot, all of the pattern time series are sorted in increasing order by their first DFT coefficients. The pattern time series are assigned new indices that correspond to their ranks in the sorted list. The x-axis 61 of the plot 60 represents the indices, i.e. ranks, of the pattern time series. The y-axis 62 represents the approximation values, i.e. DFT coefficients. A monotonic increasing curve 64 can be drawn representing the first DFT coefficients corresponding to the patterns in the pattern set after sorting.

For each one of a plurality of lengths, n, of the pattern time series, incremental DFT is used to generate a plurality of approximations of the streaming time series up to the current time. In other words, for a given pattern length, n, a plurality of approximations of the streaming time series are generated using incremental DFT. Each plurality of streaming time series approximations contains a minimum value 66, Minₛₜᵣₑₐₘ and a maximum value 68, Maxₛₜᵣₑₐₘ. These minimum and maximum values are plotted on the y-axis, and a DFT coefficient range is determined for the approximation by subtracting from Minₛₜᵣₑₐₘ and adding to Maxₛₜᵣₑₐₘ a pre-determined value α 70. Preferably, α is equal to a, the similarity threshold. Therefore, a LowerBound 72 for the DFT coefficient equal to Minₛₜᵣₑₐₘ−a and an UpperBound 74 for the DFT coefficient equal to Maxₛₜᵣₑₐₘ+a are defined. Using the plot 60, LowerBound is used to obtain a LowerIndex 76, and UpperBound 74 is used to generate an UpperIndex 78 on the corresponding ranked indices. The difference between the LowerIndex 76 and the UpperIndex 78 is the IndexRange 80 associated with the continuous stream series approximations corresponding to each pattern length n. In one embodiment, each pattern 36 can have a distinct length, i.e. length n can vary from pattern to pattern, and the approximations of a streaming time series can have different lengths. The result, therefore, is a historical record of the rank range for an “n” length pattern having a predefined degree of similarity in a continuous data stream.

Since the historical data also contain the actual historical costs associated with patterns and hence the indices, the IndexRange 80 can be associated with known costs. Therefore, for each plurality of continuous series approximations, UpperIndices, LowerIndices, IndexRanges and associated costs are generated. Since all of the UpperIndices and LowerIndices are based upon the same plot 60 generated by the corresponding pattern time series approximations, the IndexRanges and associated costs can be combined to form a cost estimator, for example in the form of a decision tree based upon the IndexRanges.

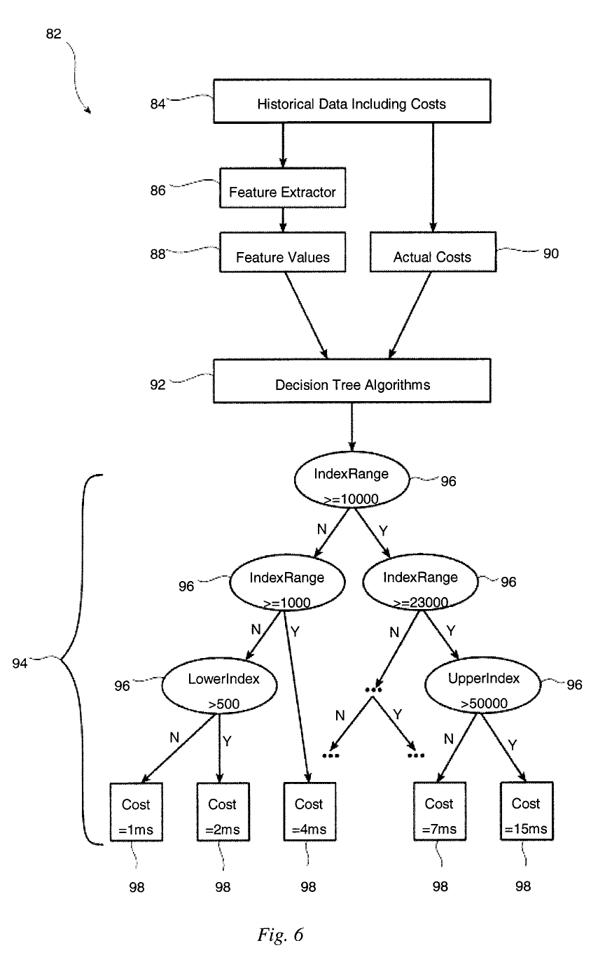

An embodiment for creating the index range decision tree 82 is illustrated in FIG. 6. From a database containing the historical data including cost data 84, features are extracted 86 and feature values are calculated 88 in accordance with the present embodiment. The actual historical costs 90 associated with the historical data from previous runs of the similarity-based search are combined with the features values 88, in particular the index ranges, and are used by a decision tree generating algorithm 92 to produce a historical data-based cost estimating decision tree 94. The decision tree contains a plurality of decision points or nodes 96 based upon the index ranges and a plurality of resulting costs 98.

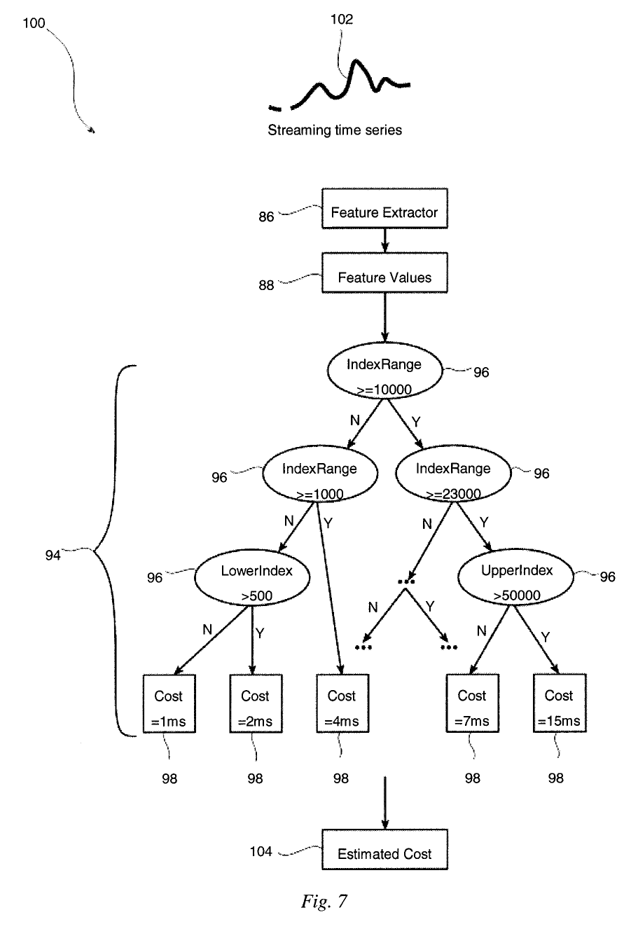

Referring to FIG. 7, an application 100 of the decision tree cost estimator 94 is illustrated for a random streaming time series 102 obtained from a continuous data stream. At each time position for the streaming time series, the relevant features are extracted 86, and the feature values are calculated 88. Since the pattern time series are static, the approximation step for the static pattern time series does not need to be performed. The feature values yield the IndexRange 80 (FIG. 5), which is used in the cost estimator tree 94 to calculate the associated cost 104.

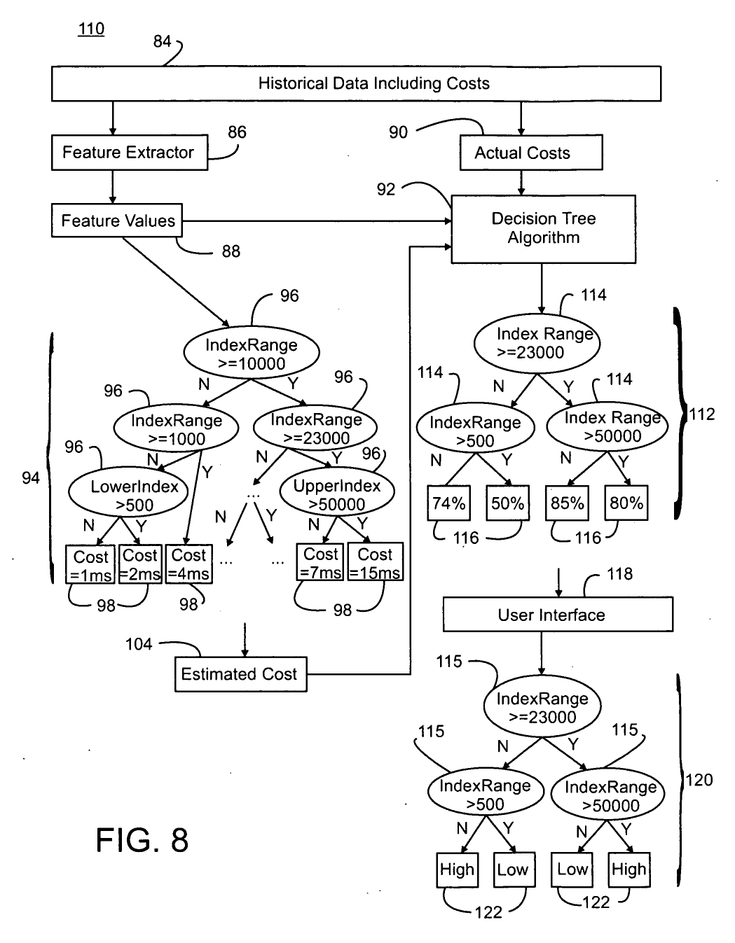

An embodiment for creating a confidence adjustor decision tree 110 is illustrated in FIG. 8. The confidence adjustor decision tree uses historical data, the actual historical costs associated with the historical data and estimated costs associated with the historical data that are estimated using the cost estimator of the present invention. In one embodiment, from a database containing the historical data including cost data 84, features are extracted 86 and feature values are calculated 88 in accordance with the present embodiment. These feature values 88 are applied to the cost estimator 94 to get the estimated cost 104 associated with the historical data using the cost estimator of the present invention. The actual historical costs 90 associated with the historical data from previous runs of the similarity-based search are obtained from the historical data 84 and are combined with the estimated cost 104 and the extracted feature values 88. In particular, the index ranges from the feature values are used.

The actual historical costs, estimated costs and extracted feature values are used by a decision tree generating algorithm 92 to produce a historical data-based confidence level decision tree 112. In one embodiment, the decision tree generating algorithm can be C4.5, which takes in the feature values 88 as the classifying attributes, and the estimation precision of the estimated cost 104 over the actual cost 90, i.e.,

$$1 - \vert \frac{( actual\_cost - estimated\_cost )}{actual\_cost} \vert ,$$

as the attribute to be classified. The historical data-based confidence level decision tree 112 contains a plurality of decision points or nodes 114 based upon the index ranges from the feature values and a plurality of leaf nodes 116, each leaf node 116 containing a resulting correctness of cost estimation. The historical data-based confidence level decision tree 112 is accessed and modified, for example, from a user interface 118, and is converted into a confidence adjustor decision tree 120. The confidence adjustor decision tree 120 contains a plurality of decision points or nodes 115 based on the index ranges and a plurality of leaf nodes 122 that each represents an ultimate decision regarding whether or not to use the estimated cost (e.g., high confidence means to use the estimated cost while low confidence means not to).

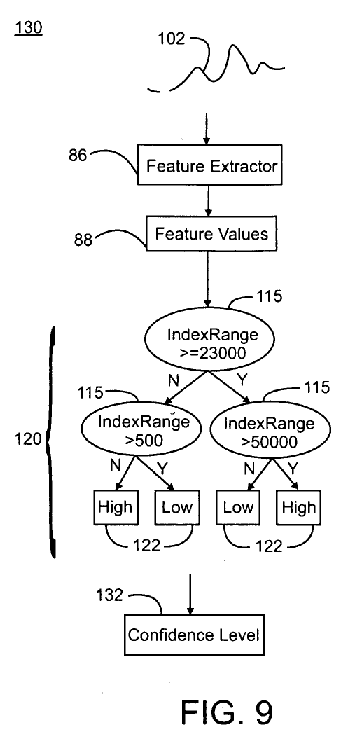

Referring to FIG. 9, an embodiment 130 illustrating the use of the decision confidence adjustor decision tree 120 is illustrated for a random streaming time series 102 obtained from a continuous data stream. At each time position for the streaming time series, the relevant features are extracted 86, and the feature values are calculated 88. Since the pattern time series are static, the approximation step for the static pattern time series does not need to be performed. The feature values yield an index range 80 (FIG. 5). This index range is used in the decision confidence adjustor decision tree 120 to yield one of the decisions 122. The resulting decision is used in confidence adjustor to determine whether or not to use the associated cost estimator 132.

The resulting costs are used to determine how to most cost effectively conduct the continuous query over the data stream. For example, the query can be conducted so as to execute those operators within the queries having the lowest associated cost first. In addition, the operators within the queries can be executed in an order such that the operators that are capable of producing a negative result for the query first and with the lowest cost are executed first. For example, if a particular operator or condition with the query has to be true for the query to be satisfied, then a false condition allows the query to be halted immediately before any other calculations or operations are conducted.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for estimating costs for continuous queries over streaming data in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of exemplary aspects of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of exemplary aspects of the present invention.

What is claimed is:

1. A method for estimating costs for continuous queries over streaming data, the method comprising:
creating a query cost estimator capable of associating costs to features in a stream of data for a continuous query;
creating a confidence adjustor capable of associating a confidence level to the costs produced by the query cost estimator; and
applying the confidence adjustor and the cost estimator to the features in one or more streams of data to estimate costs associated with conducting the continuous query over the streams of data.

2. The method of claim 1, wherein;
the step of creating the cost estimator comprises:
providing training data from historical runs of the continuous query, the training data comprising feature values and historical costs;
extracting relevant feature values from the training data;
associating historical costs with the relevant feature values; and
using the extracted feature values and associated historical costs to create the cost estimator; and
the step of creating the confidence adjustor comprises:
applying the extracted feature values to the cost estimator to obtain estimated costs; and
using the estimated costs, the associated historical costs from the training data and user criteria to create the confidence adjustor.

3. The method of claim 2, further comprising obtaining the user criteria from a user interface.

4. The method of claim 2, wherein the user criteria comprise a set of application specific rules comprising the estimated costs and the historical costs as inputs and confidence values that indicate whether or not to use the estimated costs as an output.

5. The method of claim 4, wherein the application specific rules further comprise frequencies for given difference values between estimated cost and historical costs among all the training data as inputs.

6. The method of claim 1, wherein the step of creating the confidence adjustor further comprises creating a confidence adjustor decision tree.

7. The method of claim 6, wherein the step of creating the confidence adjustor decision tree further comprises:
using feature values extracted from historical training data in the cost estimator to estimated costs associated with the historical data;
obtaining actual historical costs from the historical training data associated with the extracted feature values; and
using the actual historical costs, estimated costs and extracted feature values in a decision tree generating algorithm to produce a historical data-based confidence level decision tree.

8. The method of claim 6, wherein the confidence adjustor decision tree comprises a historical data-based confidence level decision tree comprising a plurality of decision nodes, each decision node comprising index ranges derived from feature values obtained from historical data, and a plurality of leaf nodes, each leaf node comprising a confidence level of cost estimation.

9. The method of claim 1, wherein;
the step of applying the confidence adjustor comprises extracting relevant feature values from the stream of data, inputting the extracted feature values into the confidence adjustor to obtain a confidence level to be associated with cost estimations associated with the extracted relevant feature values; and
the step of applying the cost estimator comprises accessing a stream of data, extracting relevant feature values from the stream of data, and inputting the extracted feature values into the cost estimator to derive the associated costs if the obtained confidence level is above a prescribed threshold value.

10. A computer readable medium containing a computer executable code that when read by a computer causes the computer to perform a method for estimating costs for continuous queries over streaming data, the method comprising:
creating a query cost estimator capable of associating costs to features in a stream of data for a continuous query;
creating a confidence adjustor capable of associating a confidence level to the costs produced by the query cost estimator; and
applying the confidence adjustor and the cost estimator to the features in one or more streams of data to estimate costs associated with conducting the continuous query over the streams of data.

11. The computer readable medium of claim 10, wherein;
the step of creating the cost estimator comprises:
providing training data from historical runs of the continuous query, the training data comprising feature values and historical costs;
extracting relevant feature values from the training data;
associating historical costs with the relevant feature values; and
using the extracted feature values and associated historical costs to create the cost estimator; and
the step of creating the confidence adjustor comprises:
applying the extracted feature values to the cost estimator to obtain estimated costs;
using the estimated costs, the associated historical costs from the training data and user criteria to create the confidence adjustor.

12. The computer readable medium of claim 11, further comprising obtaining the user criteria from a user interface.

13. The computer readable medium of claim 11, wherein the user criteria comprise a set of application specific rules comprising the estimated costs and the historical costs as inputs and confidence values that indicate whether or not to use the estimated costs as an output.

14. The computer readable medium of claim 13, wherein the application specific rules further comprise frequencies for given difference values between estimated cost and historical costs among all the training data as inputs.

15. The computer readable medium of claim 10, wherein the step of creating the confidence adjustor further comprises creating a confidence adjustor decision tree.

16. The computer readable medium of claim 15, wherein the step of creating the confidence adjustor decision tree further comprises:
using feature values extracted from historical training data in the cost estimator to estimated costs associated with the historical data;
obtaining actual historical costs from the historical training data associated with the extracted feature values; and
using the actual historical costs, estimated costs and extracted feature values in a decision tree generating algorithm to produce a historical data-based confidence level decision tree.

17. The computer readable medium of claim 15, wherein the confidence adjustor decision tree comprises a historical data-based confidence level decision tree comprising a plurality of decision nodes, each decision node comprising index ranges derived from feature values obtained from historical data, and a plurality of leaf nodes, each leaf node comprising a confidence level of cost estimation.

18. The computer readable medium of claim 10, wherein;
the step of applying the confidence adjustor comprises extracting relevant feature values from the stream of data, inputting the extracted feature values into the confidence adjustor to obtain a confidence level to be associated with cost estimations associated with the extracted relevant feature values; and
the step of applying the cost estimator comprises accessing a stream of data, extracting relevant feature values from the stream of data, and inputting the extracted feature values into the cost estimator to derive the associated costs if the obtained confidence level is above a prescribed threshold value.
